(19) United States
(12) Patent Application Publication
(10) Pub. No.: US 2026/0370241 A1
(43) Pub. Date: Nov. 19, 2026

(54) MULTIBAND SIGNAL PROCESSOR

(71) Applicant: Anlotek Limited, London (GB)

(72) Inventor: Jorgen Staal Nielsen, Calgary (CA)

(73) Assignee: Anlotek Limited, London, GB (GB)

(21) Appl. No.: 19/477,762

(22) PCT Filed: Apr. 22, 2024
(86) PCT No.: PCT/CA2024/050530

§ 371 Date: Oct. 22, 2025

Related U.S. Application Data
(60) Provisional application No. 63/461,274, filed on Apr. 22, 2023.
(60) Provisional application No. 63/461,883, filed on Apr. 25, 2023.

(51) Int. Cl. H04B 1/00

(52) U.S. Cl. CPC H04B 1/0007

(57) ABSTRACT

A multiband signal processor has a signal input that receives an input signal, and a sampling block that samples the input signal at a sub-sampled sampling frequency. For an input signal that has a composite band defined by a plurality of distinct bands, the plurality of distinct bands are mapped into a folded band as a plurality of sampled bands. The plurality of sampled bands are distinct within the folded band, and the folded band has a narrower bandwidth than the composite band. Additionally, spurious frequency generation may be completely mitigated through appropriate selection of a sampling frequency.

### TECHNICAL FIELD

This relates to radio frequency (RF) signal processing, and in particular, a direct RF sampling architecture for a multiband signal.

### BACKGROUND

Direct RF sampling has become an increasingly popular technique for RF signal processing due to its numerous advantages over traditional analog techniques. This technique refers to the process of digitizing radio-frequency signals directly from the antenna, without the need for intermediate frequency (IF) down-conversion stages. This technique has several potential advantages over traditional analog RF signal processing techniques. Some of these advantages include:
Improved signal quality: Direct RF sampling preserves the signal quality of the RF signal without the noise, distortion, and attenuation introduced by frequency conversion analog processing stages.
Lower system complexity and cost: Eliminating the need for IF down-conversion stages reduces system complexity and cost, as fewer components are required.
Flexibility: Direct RF sampling provides greater flexibility in selecting the appropriate sampling rate and signal bandwidth, which can be adjusted as needed for different applications.

Overall, direct RF sampling can offer many advantages for RF system design, but it may require careful consideration and trade-offs in terms of cost, complexity, calibration, and performance for a given application.

While direct RF sampling has many potential advantages, it also has some potential disadvantages, including:
Image rejection: Direct RF sampling may be susceptible to image rejection issues, where unwanted frequency components are present in the output due to the mixing of the RF signal with its image frequency. This may require additional filtering or calibration to address.
Phase noise: Direct RF sampling may be sensitive to phase noise, which may degrade the signal quality and reduce the system's overall performance.
Cost: While direct RF sampling may simplify the design of RF systems, it may require more expensive components, such as high-speed analog-to-digital converters (ADCs), to achieve the necessary performance.
Signal saturation: Direct RF sampling may be sensitive to signal saturation, where the input signal level is too high and causes the ADC to clip or distort the signal.
Complexity: Direct RF sampling may require complex calibration and digital signal processing techniques to achieve the desired performance, which may add complexity to the design and increase the system's cost.
High-speed ADC requirements: Direct RF sampling typically requires high-speed ADCs to sample the RF signal at the desired rate. This may increase the cost and power consumption of the system, particularly for wideband applications that require high sampling rates.
Complex digital signal processing: Direct RF sampling often requires more complex digital signal processing (DSP) algorithms than traditional IF-based approaches, particularly for image rejection and DC offset correction. This may increase the computational requirements and latency of the system.

### SUMMARY

According to an aspect, there is provided a a signal processor for a multiband signal, comprising a signal input connected to receive an input signal, and a sampling block that samples the input signal at a sampling frequency, wherein, for an input signal that comprises a composite band defined by a plurality of sub-bands, each of the plurality of sub-bands having a central frequency and a bandwidth, the plurality of sub-bands are mapped into a folded composite band as a plurality of folded sub-bands by the sampling block, the plurality of folded sub-bands are distinct within the folded composite band, and the folded composite band has a narrower bandwidth than the composite band.

According to other aspects, the signal processor may comprise one or more of the following features, alone or in combination: the sampling frequency of the sampling block may be adjustable, and the signal processor may further comprise a controller that is programmed with instructions to: based on the central frequency of each of the plurality of sub-bands, determine a sampling frequency of the sampling block to generate the folded composite band, and adjust the sampling frequency of the sampling block to achieve desired characteristics of the folded composite band; the controller may be further programmed with instructions to adjust the sampling frequency such that the plurality of folded sub-bands are distinct within the folded composite band; the controller may be further programmed with instructions to adjust the sampling frequency based on measurements from a downstream signal processing block; the sampling frequency may be at least twice the sum of the bandwidths of each of the plurality of distinct bands; the sampling block may comprise more than one sampling block, each sampling block sampling the input signal at a different sampling frequency; a number of folded sub-bands in the folded composite band may be greater than a number of sampling blocks, and at least two of the plurality of folded sub-bands may overlap within the folded composite band; the signal processor may further comprise a quantizer and a digital signal processor downstream of the sampling block; the composite band may comprise one or more information bands and one or more spurious bands, the digital signal processor being adapted to extract information from the one or more information bands and remove the one or more spurious bands; the signal input may comprise a multiband filter, the multiband filter being configured to generate the input signal from a received signal; the multiband filter may be tunable and comprises a plurality of passbands that are adjustable in bandwidth, frequency, gain, or combinations thereof; the signal processor may further comprise a feedback loop that extends from downstream of the sampling block to upstream of the multiband filter, the feedback loop comprising a processing block that is configured to reduce noise across a select frequency range of the folded composite band; the multiband filter may comprise a multi-pole resonator; the multiband filter may comprise a plurality of configurable resonator stages that are selectively connectable in parallel or in series; the multiband filter may comprise a plurality of tunable resonators with active feedback; the signal processor may further comprise a filter controller that is programmed with instructions to adjust the multiband filter such that the folded sub-bands are distinct within the folded composite band; and the sampling block may generate a plurality of spectral copies for each of the plurality of sub-bands, and wherein each of the plurality of folded sub-bands may comprise one of the plurality of spectral copies.

According to other aspects, there is provided a multiband receiver comprising an antenna and the signal processor for a multiband signal, wherein the signal input of the signal processor may be connected to the antenna.

According to an aspect, there is provided a method of processing a multiband signal, comprising the steps of sampling a composite signal at a sampling frequency to produce a folded composite band, the composite band being defined by a plurality of sub-bands, and wherein the sampling frequency is selected such that the plurality of sub-bands are mapped into the folded composite band as a plurality of folded sub-bands, the plurality of folded sub-bands are distinct within the folded composite band, and the folded composite band has a narrower bandwidth than the composite band.

According to other aspects, the method may comprise one or more of the following features, alone or in combination: the method may further comprise the step of adjusting the sampling frequency based on the plurality of sub-bands such that the plurality of folded sub-bands are distinct within the folded composite band; the method may further comprise the step of filtering an input signal in a multiband filter to produce the composite band, the multiband filter comprising a plurality of passbands; the multiband filter may comprise a plurality of tunable resonators with active feedback; filtering the input signal may comprise adjusting the plurality of passbands in bandwidth, frequency, gain, or combinations thereof; the multiband filter may comprise a plurality of configurable resonator stages that are connectable in parallel or in series; the method may further comprise the step of receiving the input signal by an antenna upstream of the multiband filter; the sampling frequency may be at least twice the sum of the bandwidths of the plurality of sub-bands; the method may further comprise the step of sampling the composite band using a plurality of sampling blocks, each sampling block sampling a portion of the composite band; a number of folded sub-bands in the folded composite band may be greater than a number of sampling blocks, and wherein at least two of the plurality of folded sub-bands may overlap within the folded composite band; the method may further comprise the steps of quantizing the folded composite band to produce a quantized folded band and processing the quantized folded band in a digital signal processor; the plurality of folded sub-bands may comprise one or more information bands and one or more spurious bands, and wherein processing the digitized folded band may comprise extracting information from the one or more information bands and removing the one or more spurious bands; and the sampling block may generate a plurality of spectral copies for each of the plurality of sub-bands, and wherein each of the plurality of folded sub-bands may comprise one of the plurality of spectral copies.

According to an aspect, there may be provided a multiband signal processor, such as may be incorporated into a wireless receiver, that processes multiple signals simultaneously and that uses direct sampling to digitize the plurality of signals. The multiband signal processor may have a number of functional elements for variable bandpass filtering and digitization of the signals. The multiband signal processor may be used to process a plurality of signals in different frequency bands.

In one example, the multiband signal processor may be used in a smartphone where different disparate wireless signals are processed.

The multiband signal processor may include one or more of the following features, alone or in combination:
Lower sampling frequency (sub-sampling) due to folding of multiple frequency bands into a common bandwidth for ADC processing.
Spectral compression within the folded band to remove excessing frequency gaps while simultaneously avoiding band overlap that might reduce information content of the incoming signals.
Simultaneous processing of multiple bandwidths.
Sending a processed analog data signal to the system ADC.

In other aspects, the features described above may be combined in any reasonable combination as will be recognized by those skilled in the art.

### BRIEF DESCRIPTION OF THE DRAWINGS

These and other features will become more apparent from the following description in which reference is made to the appended drawings, the drawings are for the purposes of illustration only and are not intended to be in any way limiting, wherein:

FIG. 1 is a schematic diagram of a signal processor with a top path that is a conventional receiver having a down-converter and a bottom path in which the down-converter is replaced with an ADC.

FIG. 2 is a schematic diagram of a wireless receiver that uses a zero-IF processing architecture.

FIG. 3 is a schematic diagram of a wireless receiver with direct sampling of multiple incoming wireless signals.

FIG. 4 is an illustration of a composite band that is sufficiently wide to accommodate a plurality of signals to be processed by a direct sampling radio (DSR).

FIG. 5 is a top-level block diagram of a multiband direct sampling signal processor.

FIG. 6 is an illustration of wireless signals that may be processed simultaneously by a smartphone receiver.

FIG. 7 is an illustration of a modified passband response of the multiband filter that de-emphasizes a Wi-Fi signal upstream of a digitizer.

FIG. 8a is an illustration of a sampled bandpass signal centered at the carrier frequency, f_{c}, that is folded into the frequency band, 0 to fₛ.

FIG. 8b is an illustration of a folded signal in the frequency band of 0 to fₛ.

FIG. 8c is an illustration of spectral copies of a signal centered at f_{c} that result from sampling the signal at a sampling rate of fₛ.

FIG. 9 is an illustration of a signal centered at 1.575 GHz that is into a folded band of 0 to 2 MHz.

FIGS. 10a and 10b are illustrations of signals A and B being folded into a band of 0 to 10 MHz.

FIGS. 11a and 11b are illustrations of signals A and B being folded into a band of 0 to 4 MHz with fₛ₁ and into a second folded band of 0 to 5 MHz with fₛ₂.

FIG. 12 is a block diagram of a signal processor with quantization noise w (t) from the digitizer added to the digitizer output.

FIG. 13 is a frequency plot showing a spectrum of a sampled signal after being folded.

FIG. 14 is a plot showing a spectrum of a folded band signal that has been split.

FIG. 15 is a block diagram of a first order Delta sigma circuit with a multiband filter.

FIG. 16 is a block diagram of a Delta sigma circuit with a multiband filter.

FIG. 17 is a block diagram of a second order Delta sigma with multiband filter.

FIG. 18 is an illustration of a multiband filter represented by a directional signal flow diagram.

FIG. 19 is a block diagram of a Q-enhanced resonator (QR) with an active feedback path.

FIG. 20 is an example of a QR that includes a phase shifter and variable gain block in the feedback path.

FIG. 21a is a block diagram of a multiband filter with two QRs connected in series.

FIG. 21b is a block diagram of a multiband filter with two QRs connected in parallel.

FIG. 22 is a schematic diagram of a multi-chip module (MCM) with an array of consisting of an array of QR components, summers, splitters, digitizers, a digital processing block, and a lattice of analog switches and interconnection transmission lines for implementing the multiband filter with arbitrary series and parallel connections between QR components.

FIG. 23a is an example of a series connection of two QR components tuned to different center frequencies.

FIG. 23b is a plot of the positions of the Q enhanced poles from FIG. 23a in the s plane.

FIG. 24 is an example of a multiband filter with four QR components connected in series.

FIG. 25a is an example of a multiband filter with three QRs in series.

FIG. 25b is a plot of the positions of the Q enhanced poles from FIG. 25a in the s plane.

FIG. 26a is an example of a multiband filter with QRs arranged in a series-parallel connection with QR1, QR2 and QR3 tuned to f_{c1} and QR4 and QR5 tuned to f_{c2}.

FIG. 26b is a plot of the positions of the Q enhanced poles from FIG. 26a in the s plane.

FIG. 27a is an example of a series QR connection where the Q of the pole of f_{c2} is purposely reduced to reduce the relative gain of the response at f_{c2} in comparison with the gain of the passband at f_{c1}.

FIG. 27b is a plot of the positions of the Q enhanced poles in the s plane.

FIG. 27c is an illustration that depicts the relative gain.

FIG. 28 is a block diagram of SDR (software defined radio) block diagram based on the multiband filter and M digitizers with sampling clock signals of ssₘ.

FIG. 29 is an illustration that shows the sampling clock signals.

FIG. 30 is a flow chart of notional top layer logic flow for self-configuration.

FIG. 31a is a plot of the overall frequency response of a filter showing the passband and the spurious bands.

FIG. 31b is a Nyquist plot related to FIG. 31a.

FIG. 31c is a zoomed in passband related to FIG. 31a.

FIG. 31d is a calculated Q enhancement related to FIG. 31a.

FIG. 32a a plot of the overall frequency response of a filter showing the passband and the spurious bands.

FIG. 32b is a Nyquist plot related to FIG. 32a.

FIG. 32c is a zoomed in passband related to FIG. 32a.

FIG. 32d is a calculated Q enhancement related to FIG. 32a.

FIG. 33 is a frequency plot, where a narrow band at f₂ is the desired band and the lower band responses at f₁ and f₃ are spurious responses.

FIG. 34 is a Nyquist plot showing an operating point, a desired passband frequency of f₂ and spurious frequency bands of f₁ and f₃.

FIG. 35 is a plot of the spectral content of the desired signals and the spurious bands compressed into the folded band created by a subsampling S/H (sample and hold).

### DETAILED DESCRIPTION OF PREFERRED EMBODIMENTS

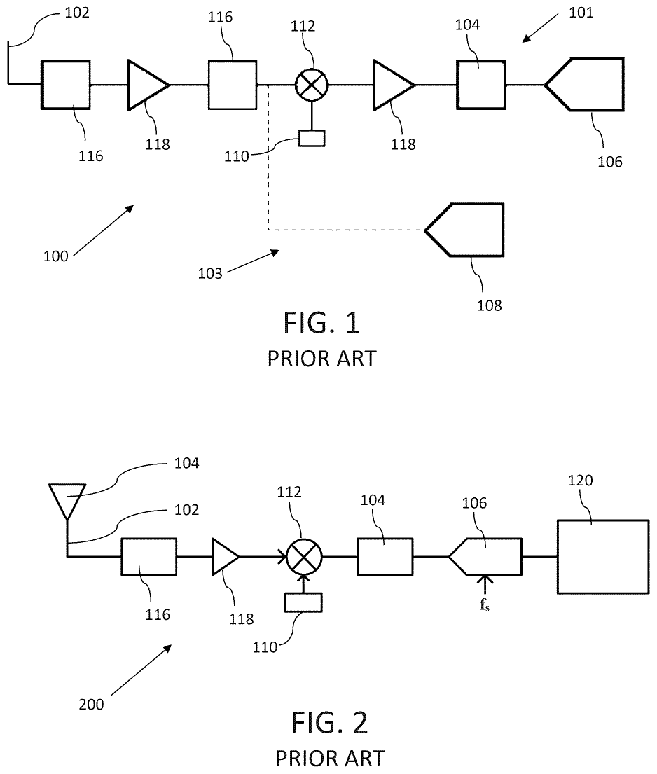

A multiband signal processor 10, generally identified by reference number 10, will now be described with reference to FIG. 1 through 35.

### Direct RF Sampling Overview

FIG. 1 depicts as example of a signal processor 100, where the top path 101 represents a signal processor that uses down-conversion, and may be contrasted with a bottom path 103 that represents a signal processor based on direct RF sampling. While the signal processing system described below is generally given in the context of a signal that arrives wirelessly via an antenna or equivalent, the discussion may apply to wireless or non-wireless systems. An input signal 102 is received, and may pass through one or more input RF filters 116 and amplifiers 118. Top path 101 of processor 100 uses a local oscillator (LO) 110 and a mixer 112 to down-convert the signal prior to being processed in an ADC block 106. The down-conversion may be a zero IF (intermediate frequency) that goes to baseband, where filter 104 is a LPF (low pass filter) upstream of ADC 106. It may also be a near IF (that is, a frequency close to baseband) where filter 104 is a passband filter. Bottom path 103 does not use down-conversion and simply processes the signal using an RF ADC 108, which may also be called a direct sampling ADC. An RF ADC is an ADC that can sample an RF signal with a very fast sample and hold (S/H). The sampling rate may be based on the Nyquist rate of the passband rather than twice the carrier frequency, which is generally much higher.

A benefit of eliminating the down conversion is that LO 110, mixer 112, and IF filter 104 create some level of signal problems that may be avoided. For example, LO mixing generates phase noise and spurious band responses, which places performance requirements on RF filter 104. Baseband delta sigma may be applied to remove some of the ADC quantization noise, but not the noise generated by the down conversion process. On the other hand, the IF filtering is relatively straight forward to implement and ADC 106 may operate at the Nyquist rate, while RF ADC 108 is more difficult to implement as an RF anti-aliasing filter may be required. In addition, RF ADC 108 requires a fast sample and hold.

### Smartphone Overview

The present discussion relates to a multiband signal architecture that permits multiple signal bands to be processed simultaneously. Such an implementation may be of particular use in a smartphone. As such, in the discussion below, a smartphone may be used as an example, and to give more context to the discussion. However, it will be understood that the signal processing described herein may also be used in other applications where it may be advantageous to process multiple signals simultaneously, such as an electronic surveillance receiver, a specialized military communications receiver, international smartphone implementations, collaborative first responder networks, satellite communications, sensor networks, IoT networks, etc.

A smartphone in this context is assumed to be a battery powered processing system in which the inputs are multiband wireless signals that are simultaneously processed. For instance, in a typical smartphone one may find that a GPS signal, a Wi-Fi signal, and a cellular signal are processed simultaneously. For a conventional smartphone, the processing of these signals may involve:
1. A plurality of antennas to capture the wireless signals,
2. A plurality of analog RF receiver channels to amplify and filter the wireless signals,
3. A plurality of digitizers to convert the analog signals into digital signals, and/or
4. A digital processing block to process the digital representation of the signals to extract the information from these signals.

The direct sampling architecture may be usefully incorporated into a wireless transceiver system where there is a significant processing component such that the system is primarily a digital processor with the wireless interface as a peripheral. This is emphasized by the development of the wireless phone which has evolved from being primarily a radio with minor digital processing to a smartphone which is essentially a computer with a plurality of radio front end components that are attached. Future systems may be based on a generic processing platform with high-speed digitization and digital processing. The plurality of simultaneous radio channels required will feed into this generic processing block with emphasis on optimizing the usage of the processing resources and minimizing the overall power consumption. An emphasis will be on flexibility in the configuration of the radio channels and processing for a wide variety of combination of applications. A key point is that the general processing resource may be given, and the radio peripherals are matched to this resource and not the other way around, as has been the case hitherto.

The multichannel architecture may also be usefully incorporated into a system that uses wireless signal digitization based on direct sampling. Direct sampling has evolved as a possibility in step with the evolution of high-speed integrated circuit technology. This has led to transistor switching devices which are sufficiently fast and low power to enable the implementation of signal digitization in the range of tens of giga-samples per second at relatively low power and low cost. Likewise, the rate of digital operations that may be practically achieved in small processing platforms such as a smartphone has drastically increased. This is a necessary compliment to match the higher digitization rates available.

### Radio Receivers

Typically, a radio receiver will process a single wireless frequency channel unless the wireless channels are contiguous in frequency. For example, a Wi-Fi receiver may process several frequency channels simultaneously, but these channels are contiguous in frequency. Channels separated by gaps in frequency such as the two Wi-Fi bands at 2.4 GHz and 5 GHz cannot be processed by the conventional radio receiver simultaneously: two separate receiver channels are therefore required.

Referring to FIG. 2, an example of a radio receiver 200 for processing wireless signals is shown. Starting from the left, an input signal 102 is entered into the receiver from an antenna 114. Signal 102 filtered by a bandpass filter (BPF) 116, which passes the frequencies of the desired signal at a carrier frequency (f_{c}). The filtered signal is then amplified in an amplifier 118 and then frequency converted to a baseband signal using a LO 110 and mixer 112. In the baseband portion of the receiver, the signal is filtered through an LPF 104 to remove frequency content outside of the desired bandwidth of the converted signal. The signal is then sampled by an ADC 106 at a sampling frequency of fₛ. The digitized sequence of samples is then processed in a DSP 120. DSP 120 extracts the information content of the signal. The digitization may be a quadrature architecture. It may also be based on an IF signal.

A limitation of receiver 114 is that it can only process one wireless signal, which is an issue for multi-function and multiband devices such as a smartphone. In a typical smartphone, there are several signals that are simultaneously processed or processed in parallel, which could be GPS, cellular, Wi-Fi, Bluetooth, etc. Also, Wi-Fi could use two different bands at 2.4 GHz and 5 GHz. The smartphone therefore needs a plurality of radio receiver channels, each channel of the architecture as shown in FIG. 2, which inflates the system cost, size, complexity and power requirements of the smartphone.

The term “simultaneous” in this context implies that each of the desired multiple signals are to be processed in real time with an arbitrary but known latency. For example, in a smartphone, the Wi-Fi and GPS may be combined, with timing being critical for positioning as they are processed in different RF receivers. In the architecture described herein, where the signals are processed in a combined receiver, timing alignment becomes easier as the complex processing in the DSP is deterministic and, when care is taken, may be exact, or nearly exact, timing. In some implementations, the term “simultaneous” may also refer to the ability to process signals in parallel.

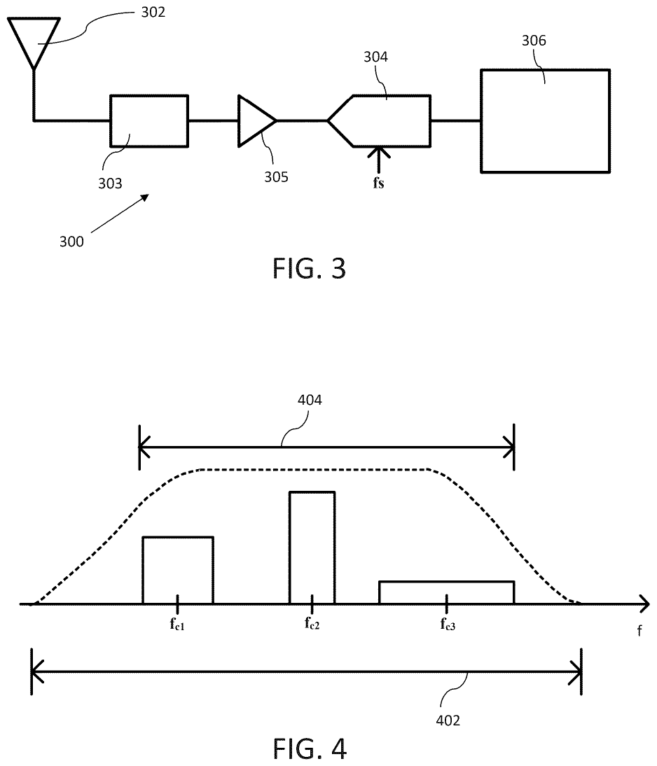

As will be discussed below, it is possible to process multiple signals simultaneously with one channel using a multiband signal processor 300 that uses a direct sampling radio (DSR) architecture as shown in FIG. 3Error! Reference source not found. A broadband antenna 302 is used that is capable of receiving wireless signals that includes multiple bands, and the broadband signal is then that is filtered with a bandpass filter (BPF) 303 that has a filter bandwidth that is sufficiently broad to include all of the frequencies of interest, such as from 500 MHz to 6 GHz. The filtered signal is amplified in an amplifier 305, digitized by a high-speed digitizer 304, and then processed in DSP 306. DSP 306 is used to filter out the individual desired signals, then isolate and process them for information content. An issue with this architecture is that the digitization will generally be at a very high rate to accommodate the bandwidth of the input signal emanating from bandpass filter 303, and the digital processing by DSP 306 will also generally be done at a very high rate. This results in a system that may be expensive to implement and may require significant power to operate.

It is also possible to implement a DSR that only works on a narrowband desired signal. The digitizer would have a high-speed sample and hold (S/H) circuit that is able to accommodate the high carrier frequency of the desired signal as is also required in the full bandwidth direct sampling scheme. However, the rate of the digitization (sampling rate) may be modest. The sampling rate would be at least the Nyquist rate related to the bandwidth of the BPF, which is typically much less than the conventional Nyquist sampling rate requirement of being twice the highest frequency of the signal which is about twice the signal carrier frequency of f_{c}.

Referring to FIG. 3, consider multiband signal processor 300 that is digitizing a wireless signal of bandwidth B, where B is much less than the carrier frequency of f_{c}. If BPF 303 is centered on the signal, and has a passband of B, then the digitization rate required is 2B, which is the Nyquist rate. However, it may be difficult to implement a conventional passive BPF that has high frequency selectivity with a bandwidth of B that is tunable. The tunability of the parameters of B and the center frequency of f_{c} is required as the receiver has to be configurable to receive various signals over a range of frequency channels. Inevitably, the implemented BPF will have an actual bandwidth of Bₐ that exceeds B significantly and also has limited out of band rejection. This is represented in FIG. 4, where the actual Nyquist bandwidth 402 is broader than the effective bandwidth 404. Hence, in a practical implementation, the digitization rate may have to be 2Bₐ as opposed to 2B. Another issue is that BPF 303 may need to be tuned in both bandwidth and center frequency. A tunable filter, where both the bandwidth and the center frequency are tunable and that has a steep cutoff especially as the bandwidth becomes larger, may be difficult to realize.

### Multiband Considerations

As previously stated, an issue in a highly integrated platform, such as a smartphone, is that there are several wireless signals in different non-adjacent frequency bands that need to be processed. The conventional implementation is that a separate radio signal digitization channel would be used for each signal. However, this requires significant circuit implementation that may not be able to be integrated into a single chip due to the potentially high frequencies of 6 GHz or more.

Referring to FIG. 4, another issue is that there may be noise and other interference signals that are not desired in the frequency gaps between the bands of the desired signals (f_{c1}, f_{c2}, f_{c3}), as shown in FIG. 4. However, in the context of a wide band DSP as discussed with respect to FIG. 3, the undesired signals will be digitized along with the desired signals. Consequently, digitizer 304 needs enough dynamic range such that these interference and noise signal components are able to be expunged in the digital processing. Hence, referring again to FIG. 4, not only does the DSR digitization rate require a high sampling rate of 2Bₐ where Bₐ is the composite bandwidth 402, as in the example of FIG. 4, it additionally requires a large dynamic range to accommodate all of the spectral content in the frequency gaps between the desired signal frequency bands 404. This is wasteful processing that consumes power, in terms of the digitizer as well as the digital processing.

As discussed herein, a signal with desired signals may be referred to as a composite band, which is an aggregate of desired signals in different bands. The composite band may be defined by the range of frequencies from the lowest frequency of spectral significance of the desired signal with the lowest center frequency and the highest frequency of spectral significance of the desired signal with the highest center frequency. The actual bandwidth of Bₐ will depend on the steepness of the edges of the bandwidth filter, where a larger filter bandwidth may be required as steep transitions may be difficult to implement in a tunable wide bandwidth filter.

Additionally, a DSR with a sampling digitizer may be used to process the simultaneous wireless signals. However, as discussed above, the bandpass filter minimum sampling rate of the DSR is the Nyquist rate of the composite signal of the plurality of the desired signals. Hence the digitization rate may become large. Furthermore, as it is difficult to realize a tunable filter with wide bandwidth that has steep transitions at the band edges, the effective Nyquist rate may become larger, further exasperating the implementation requirements of the digitization rate required.

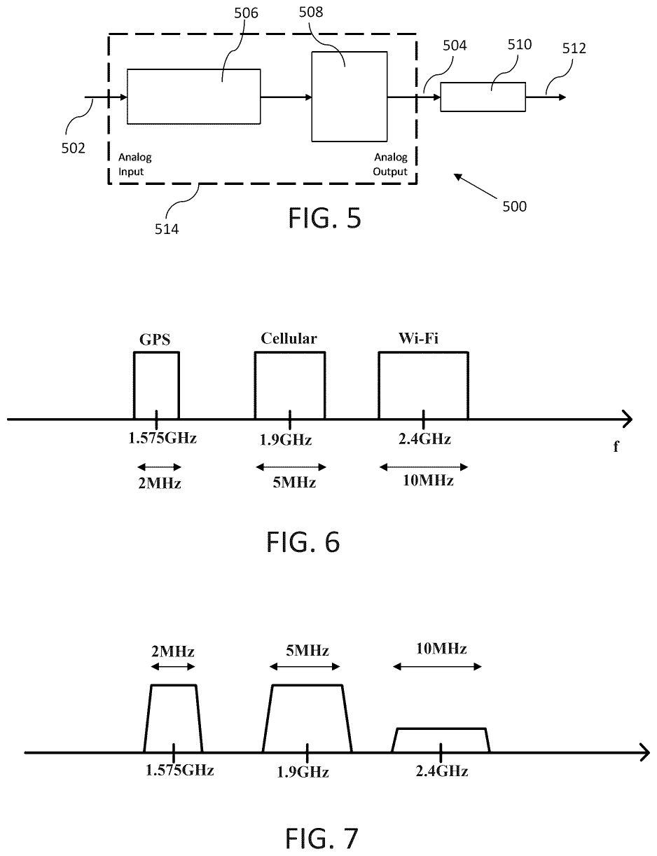

Referring now to FIG. 5Error! Reference source not found., a top-level block diagram of a multiband direct sampling signal processing architecture 500 is shown. Architecture 500 has a multiband analog signal input 502 that is simultaneously processed into a single band analog output 504 by a multiband filter 506 and a sampler 508 that may then be processed further in a quantizer 510 to produce a digitized output 512. The single band analog output 504 preferably has a narrower bandwidth such that digitized output 501 may be processed digitally in an ADC that is able to extract the multiband input signal information at significantly lower system power requirements. A typical ADC may incorporate both a sample-and-hold circuit and a quantizer circuit as discussed elsewhere, however the functions may also be performed by discrete components.

Sampler 508 may be a device that takes time-based instantaneous samples of a continuous time signal. The analog portion of signal processor 500 is found in block 514, and includes a multiband filter 506 and a sampler 508. Sampler 508 may be implemented as a sample and hold (S/H) circuit. The output of sampler 508 may be analog, or in other words, a continuous variable of a physical property, which may be a voltage level, an electric current level, or other variable. While the output of sampler 508 is an analog signal, it will be suitable for processing by quantizer 510. For example, the output may have a step-wise appearance where sampler 508 is a S/H circuit. Thus, the input signal into quantizer 510 will be continuous in time and value, and an output will be a digital signal, such as an approximate digital representation of this signal value sampled at a time instance. More generally, a digitizer may be defined that includes both a sampler circuit and some means of sample quantization to provide the digital output.

### Multiband Signal Filtering

Beneficial characteristics of a tunable multiband filter as discussed herein may include:
Low Insertion Loss
Stable operation
Linear control
High Q, such as a Q of 1,000 or more
Settling time of less than 10 microseconds

In some implementations, the multiband signal filter may include multiple passbands that correspond to desired signals to be processed. The passbands of the multiband filter may be tunable in frequency, bandwidth, and/or gain, and may be tuned independently or in combination, based on the signals to be processed from the input signal that is received at the input of the multiband filter. The multiband filter may be made up of a plurality of active Q-enhanced, stable, and tunable resonators (QR), such as those disclosed in U.S. Pat. No. 10,050,604 (Nielsen) entitled “Variable Filter”.

In some implementations, the multiband signal processing architecture may include a configurable bandpass filter (CBPF) that allows a DSR to process a plurality of simultaneous wireless signals while reducing or minimizing the digitization rate. The CBPF may be tunable in frequency, bandwidth, and/or gain, and/or configurable such that the digitization process of a DSR may be optimized to handle multiple signals, with each band in the CBPF being controllable by a controller. The CBPF may be programmable, such as with settable parameters.

A multiband signal processor based on a multiband filter may be further generalized. Consider a generic processing platform that consists of a digital processing unit, a plurality of digitizers, and a plurality of QR devices. These may be configured into a receiver processing architecture using an array of digital and analog switches. In this way, a DSR-based receiver may be implemented that is optimum in terms of the overall receiver dynamic range for the plurality of desired wireless signals to be processed and the power efficiency.

In describing the multiband filter and the application within the DSR, consider an implementation of a smartphone receiver that is tasked to process three signals simultaneously. These could be a GPS signal at 1.575 GHz, a cellular signal 1.9 GHZ, and a Wi-Fi signal at 2.4 GHz as illustrated in FIG. 6. The discussion below may be generalized to other applications with other signals and frequency bands. In addition, the signals of interest may be centered at different carrier frequencies. As such, the specific numerical examples provided herein should be considered merely representative.

The multiband filter may be used to form a highly frequency selective passband comprising the three passbands that are at the correct center frequency for the three wireless signals to be processed that correspond to the bandwidths of the signals in FIG. 6. That is a smartphone multiband filter, for example, may have:
A passband centered at 1.575 GHz with a bandpass of 2 MHz for the GPS signal,
A passband centered at 1.9 GHz with a bandwidth of 5 MHz for the cellular signal and,
A passband at 2.4 GHz with 10 MHz bandwidth for the Wi-Fi signal.

With this composite band frequency response of the multiband filter, only the desired signals are passed to the system digitizer. All of the interference and noise signals that are present in the frequency gaps between these desired bands are suppressed. Therefore, the digitizer does not have to expend sampling and processing resources on these nuisance signals that are only expunged in the digital processing with no contribution to the information output of the receiver. As they are blocked by the multiband filter, and therefore not present as part of the composite band into the digitizer and digital processing, the resources required to process these nuisance signals are reduced or avoided.

### Gain Optimization of Individual Bands

In some examples, the gain of the various bands of the multiband filter may be varied. In the example of FIG. 6, the Wi-Fi signal at f_{c3} may be of higher amplitude than the cellular signal or the GPS signal. The digitizer may have a given effective number of bits (ENOB) to process all three signals that are superimposed in time domain. Hence, to improve the overall aggregate information output of the receiver, a higher gain may be applied to the GPS and cellular signals relative to the Wi-Fi signal. This may be achieved by modifying the response of the multiband filter as illustrated in FIG. 7. The algorithm for optimizing the relative gains of the signal bands may be based on an information theoretic approach which accounts for the ENOB of the sampler, as is known in the art.

### Sampling Overview

Once filtered by the multiband filter, the individual signals in the passbands are sampled to cause the passbands to be “folded” or compressed into a folded band that is narrower than a bandwidth that is encompasses the pre-sampled signals. In other words, the passbands after sampling will have less space between them. An incoming signal, whether upstream or downstream of a filter, with multiple bands may be considered to be a composite band, and the bands within the composite band to be sub-bands. Within the sampled signal, there may be identified a folded composite band made up of folded sub-bands, where each folded sub-band is a spectral copy of the pre-sampled sub-band. As discussed herein, through an appropriate selection of the sampling frequency fₛ, the folded sub-bands may be distinct within the folded composite band, and the folded composite band may have a smaller bandwidth than the pre-sampled composite band.

By way of example, suppose that an input signal is represented as

r(t)=Re{g(t)e^{jπf}^{_{c}}^{t}}

where Re{ } denotes the real part of the bracketed expression, g (t) is an arbitrary complex valued baseband signal with a one-sided bandwidth of B, and f_{c} is the carrier frequency.
Suppose that this is sampled at a rate of fₛ by an idealized impulse train sampling function which in the time domain may be represented as

$$s ( t ) = {\sum }_{n = - ∞}^{∞} δ ( t - \frac{n}{{f}_{s}} )$$

This may be expressed in the frequency domain as

$$S ( f ) = {\sum }_{m = - ∞}^{∞} δ ( f - {mf}_{s} )$$

Combining, the spectrum of the ideal sampled signal is

$${R}^{*} ( f ) = {\sum }_{m = - ∞}^{∞} G ( f - ( {f}_{c} - {mf}_{s} ) )$$

where the * implies sampled. This provides spectral copies of R(f) with a frequency translation. For one value of m, the spectral frequency copy will be within the range of −B to B where B<fₛ. Hence fₛ may be much smaller than f_{c}. It may actually be as low as 2B. This is the Nyquist sampling criteria. Note that the complex signal may require quadrature sampling.

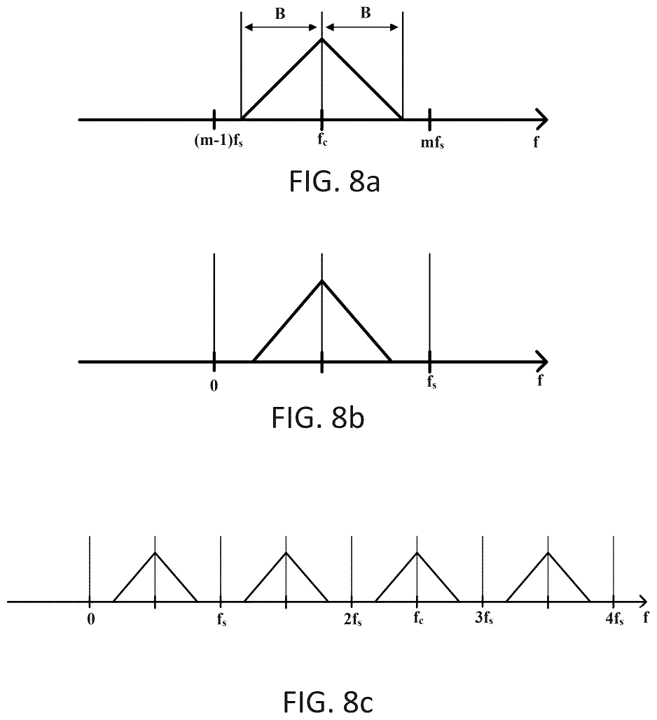

A representation of the results of sampling is shown in FIG. 8c, where multiple spectral copies of an input signal centered at f_{c} are generated as a result of the sampling process. In the discussion below, appropriate selection of the sampling frequency may permit a copy of each desired signal to be generated within a desired folded band, which may then be subjected to further processing.

Consider specifically the range of frequencies from 0≤f<fₛ. As observed, the frequency of the original band pass signal over the range of f_{c}−B<f<f_{c}+B may be folded into the range of frequencies from 0≤f<fₛ provided that fₛ>2B. This is independent of the carrier frequency and is illustrated in FIG. 8a and FIG. 8b. The original signal content may be recoverable, provided that any information-reducing overlap is minimal. This is discussed below.

The DSP shifts the frequency by the residual amount of (f_{c}−mfₛ), where m is the value that folds the bandpass signal into the range of 0 to fₛ. To do this, there is a DSP operation that multiplies the signal by exp(−j2π(f_{c}−mfₛ). Note that this may not be necessary to do, or to do this with high precision. It depends on the objective operations necessary for extracting the information from the signal. The frequency translation may be combined with other operations such as filtering, decimation, matched filtering and data sampling.

### Band Folding for Spectral Compression to Reduce Sampling Frequency

The sampling frequency fₛ, may be appropriately selected such that the bands of the desired signals may be folded into the frequency band of 0 Hz to fₛ Hz without overlapping, which would otherwise reduce information content in the separate bands. In this discussion, the term ‘folded band’ refers to the frequency band of 0 to fₛ into which the sampled signals are mapped.

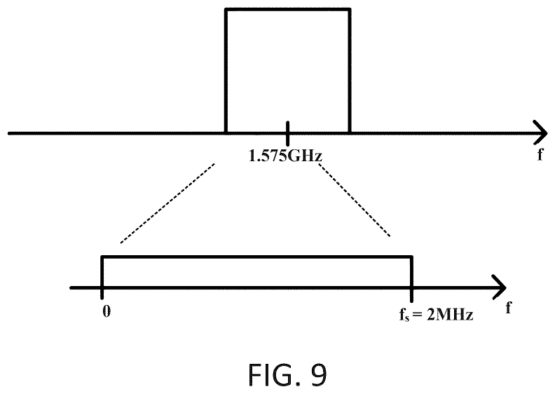

Suppose that a desired signal with a carrier frequency of f_{c} is input into the digitizer sampling at fₛ. Then the folded band extends from 0 Hz to fₛ Hz. The carrier signal f_{c} is then translated to a frequency of mod(f_{c}, fₛ), where mod(a,b) denotes the modulus function, that is the remainder of a/b. For instance, consider the GPS signal at 1.575 GHz being sub-sampled at a 2 MHz rate. Then the folded band extends from 0 Hz to 2 MHz, as shown in FIG. 9.

The digitized signal in this band may then easily be processed digitally to extract the full information of the GPS signal without loss. However, if the GPS signal is bandlimited by the multiband filter to a bandwidth that exceeds 2 MHz, then a portion of the signal spectrum will be translated into the 2 MHz wide folded band with the spectrum of the excess bandwidth overlapping the other spectral components from 1574 to 1576 MHz that are mapped into the 0 to 2 MHz of the folded band and thereby cause self-interference. This results in avoidable information loss of the receiver. Mitigation would require a sharper multiband filter bandwidth limited to the 2 MHz range from 1574 to 1576 MHz or an increase in fₛ that is commensurate with the actual bandwidth of the multiband filter.

It may be noted that the signals are still separated by a deterministic frequency band. For example, the GPS band is known to be 1.57542 GHz+/−2 MHz. The sampling frequency may be known to within, say, 10 ppm with a VCXO (voltage-controlled crystal oscillator) with a tolerance of 16 kHz. Same as the cellular and Wi-Fi. Now a sampling frequency fₛ may be found that satisfies the mod(f_{c},fₛ) criteria, which means the bands are separated in the folded band from 0 Hz to fₛ. But the frequency of the Wi-Fi, GPS and cellular folded bands are known, such as within the 10 ppm tolerance.

This may permit an fₛ to be determined that will satisfy no overlapping bands and provide a guard band for the 10 ppm tolerance. Hence the GPS can be precisely DSP processed as in a regular GPS receiver. The DSP does not have to know anything about the signals themselves—only the original RF frequency bands.

In the case of multiple passbands, an appropriate selection of fₛ results in the set of desired signals corresponding to these passbands mapped into the folded band while maintaining the signals as distinct. Suitable strategies, such as an algorithm, based on known methods, may be used to determine the minimum value of fₛ to ensure the signals are distinctive.

In general, an analog signal is associated with a specific and deterministic frequency band. Each frequency band also has a central frequency, which may be a characteristic frequency of the frequency band, or a frequency suitable for describing the frequency band, whether it is the geometric center frequency or not. A plurality of such signals may be associated with a plurality of deterministic frequency bands that are preferably non-overlapping in frequency. In such a case, the signals will occupy distinct regions or intervals of the frequency spectrum. Hence a distinct band may be defined as a frequency band of a desired signal (desired in the sense that it is to be processed for extraction of information) that is non-overlapping in frequency with respect to all other desired signals to be processed by the receiver. In some cases, causing the bands to be non-overlapping may be achieved by preconditioning the signals, such as by controlling the multiband filter.

In other situations, as discussed below, there may be some overlap between folded bands, however the signals may be processed downstream in such a way that they are separable. In other words, the distinctiveness of folded passbands does not require that they be discrete, i.e. with no overlap, but considered in the context of the downstream processing, the folded bands will be distinct if sufficient information in each band can be extracted with nominal interference from other bands, which may allow for some overlap in the analog space. As will be understood, the degree of overlap that is acceptable will depend on the degree of information loss that is acceptable in a given application, and may be a parameter that is defined by the user or designer.

### Band Folding Examples and Discussion

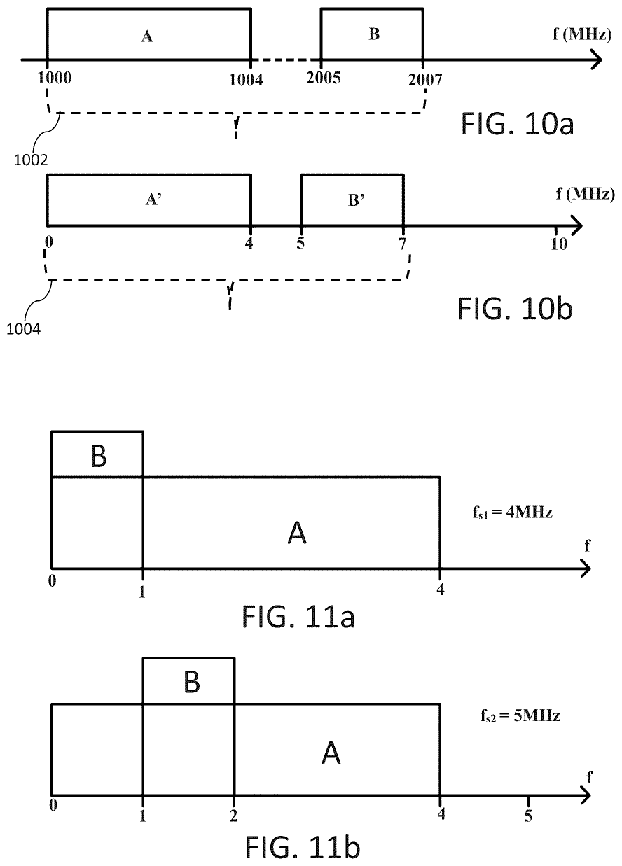

Consider an example of two desired signals of signal A in the frequency band of 1000 MHz to 1004 MHz and signal B in the band of 2005 MHz to 2007 MHz, as seen in FIG. 10a. Together, these may be considered to fall within a composite band 1002, i.e. a band from the lowest frequency of signal A to the highest frequency of signal B. Suppose a quadrature sampling frequency of 10 MHz was selected, then the A and B signals would be folded into the band of 0 to 10 MHz as shown in FIG. 10b, labeled A′ and B′. After sampling, signals A′ and B′ may be referred to as sampled signals, and together may be considered to fall within a composite folded band 1004, i.e. a band from the lowest frequency of sampled signal A to the highest frequency of sampled signal B. Note that the frequency folded signals A′ and B′ are not overlapping and therefore do not interfere.

If the number of desired signals is increased, then the minimum fₛ that satisfies the non-overlapping criteria may become large, such that the fₛ required may exceed the capability of the digitizer. In this case there are various options, some of which are discussed below.

One option may be to accept a partial overlap of the desired signals in the folded band. If the signals are interference-tolerant, such as spread spectrum signals, then the small loss in the digital processing output of the SNR (signal to noise ratio) for the set of desired signals may be acceptable. In this case there is a direct trade off that can be made by lowering the fₛ requirement for a drop in SNR. If there is a margin in the SNR, then all the information of the processed desired signals may be extracted without loss despite the self-interference caused by the overlap in the folded band.

Another option may be to limit the pass bandwidth of the overlapping signals in the multiband filter. The digital processing can typically be modified to compensate for the increased ISI (inter-symbol interference) resulting from the narrowing of the bandwidth. The overlap in the folded band can then be avoided, reducing the information loss due to mutual interference. However, there may still be a loss in the digital processed SNR of the desired signals as a portion of the signal has been removed prior to detection.

A further option may be to use a plurality of digitizers with different sampling patterns. For example, two or more digitizers may be used with different sampling rates. In one example, with respect to FIGS. 11a and 11b, there may be two digitizers with sampling frequencies fₛ₁ and fₛ₂ for the signals A and B, where FIG. 11a shows the overlap between A and B where fₛ₁ is 4 MHz, and FIG. 11b shows the overlap between A and B wherefₛ₂ is 5 MHz. In this case, signals A and B are overlapping in the folded band in both digitizer outputs. However, if the superpositions of A and B of the two digitizer outputs are linearly independent, A and B will be separable with digital processing.

A further option may be to have a plurality of digitizers, each at a different sampling frequency, where the set of sampling frequencies is non-commensurate. Then the aggregate of the digitizer outputs may be combined to generate an interpolation of the desired signals that may then be completely separated without mutual interference. These isolated signals can then be processed to extract the information contained in the signals.

### Configuration of the Multiband Signal Processor

For a configurable multiband filter, the multiband filter may be configured or reconfigured once the center frequencies and bandwidths (BW) of the incoming multiband signal have been determined. The multiband filter may be configured in both center frequency and bandwidth (BW) by interconnecting and/or tuning filters, calibrating these filters separately and/or together, and then confirming the required bandpass performance against input system requirements, cognizant of system level constraints. This approach may also be used in designing a multiband filter prior to manufacturing, based on the signals that are expected to be received during operation, in which case the filters may have limited tuning capabilities.

### System Digitizer

In general, it is preferable to reduce the sampling rate of the system ADC in order to lower the overall system power consumption, particularly in a battery powered system. However, lowering the sampling rate may lead to aliasing, where higher frequency components fold back into the lower frequency range, causing distortion. In some cases, this distortion may be beneficially exploited for signal processing purposes. For example, in certain types of digital receivers, aliasing may be used to convert high frequency signals into low frequency signals, allowing them to be more easily processed using digital signal processing techniques. This approach is known as under-sampling, sub-sampling, or sub-Nyquist sampling.

Following the sampling, there will be a sub-sampling digitizer where the sampling frequency of fₛ can be much less than in a conventional DSR without the configurable filter. In the given example of FIG. 6, a minimum required fₛ is twice the frequency of the highest to the lowest frequency of the composite band into the digitizer which is 2. (2405-1574) MHz or 1862 MHz for this example.

As discussed previously, it may be difficult to realize a BPF of sufficiently steep frequency transition for such a wide bandwidth, in which case the filter may have a less steep frequency transition at the band edges, which increases the effective bandwidth and inflates the required sampling rate. For this example, the larger filter bandwidth would require a sampling rate now of about 2500 MHz. However, the actual aggregate bandwidth will be lower, for example, in the case of three desired signals with bandwidths of 2 MHz, 5 MHz, and 10 MHz, the aggregate bandwidth is 17 MHz, such that if the bands were contiguous in frequency without any gaps, then the sampling rate required is twice the aggregate bandwidth, or 34 MHz. Digitization and digital processing at the rate of 34 MHz is less intensive in terms of processing hardware and power than having to process at a 2500 MHz sampling rate. Furthermore, the ENOB (effective number of bits) of the conventional sampling has to be higher than that of the ENOB of the sampling if the bands were contiguous. This further increases the requirements of the digitization and the digital processing.

### Bandpass Delta Sigma Applied to the Multiband Filter

In some implementations, Delta Sigma (DS) modulation may be used, where oversampling is used to encode signals into low bit depth digital signals at a very high sample-frequency. Delta Sigma is a signal modulation method that is used to remove or reduce processing noise that may occur during signal quantization. It is a high frequency signal sampling method that processes analog signals into digital signals with a low number of bits of signal information content in each sample, but at a very high sampling frequency-called oversampling-relative to the signal frequency. This moves processing quantization noise to higher frequencies well above the original signal's bandwidth. Subsequent low-pass filtering during demodulation easily removes this high frequency noise. DS uses a negative feedback loop, and may be used to increase the quality of the lower bit depth, correct for quantization errors, and reduce the effect of noise.

Without Delta Sigma (DS) signal processing, the quantization noise of the digitization process is white and approximately independent of the signal. The level is

$$10 {log}_{10} ( \frac{{Δ}^{2}}{12} ) dB ,$$

where Δ is the resolution step size of the quantizer.

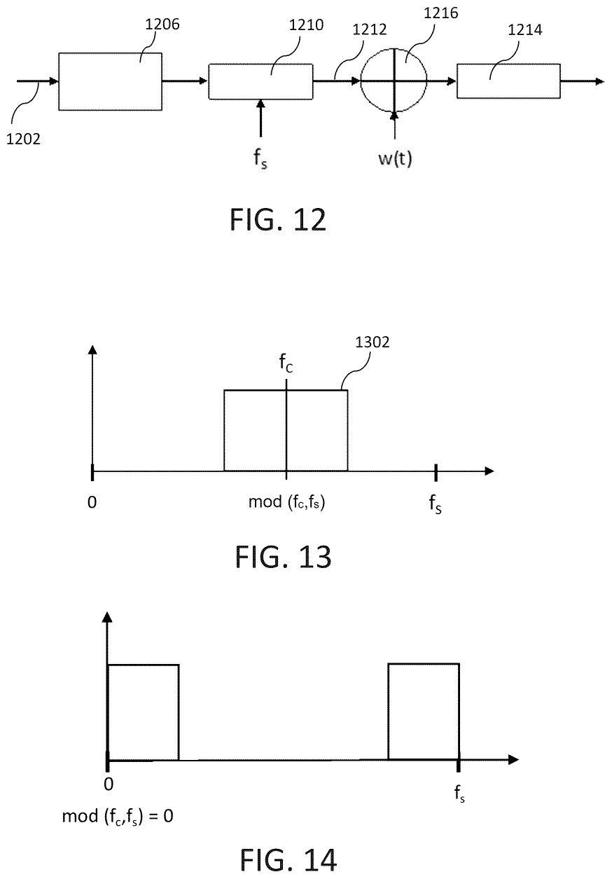

Referring to FIG. 12, a signal 1202 is processed by multiband filter 1206 and digitizer 1210. The equivalent quantization noise w(t) is shown as added to digitizer output 1212 at a summer 1216 before a DSP filter 1214. The RF analog input signal 1202 is at a center frequency of f_{c} and has a bandwidth of B. It will be folded into the band of 0≤f<fₛ. The folded spectrum 1302 is as shown in FIG. 13. Signal 1302 in the folded band is offset from 0 Hz and is therefore equivalent to a bandpass signal.

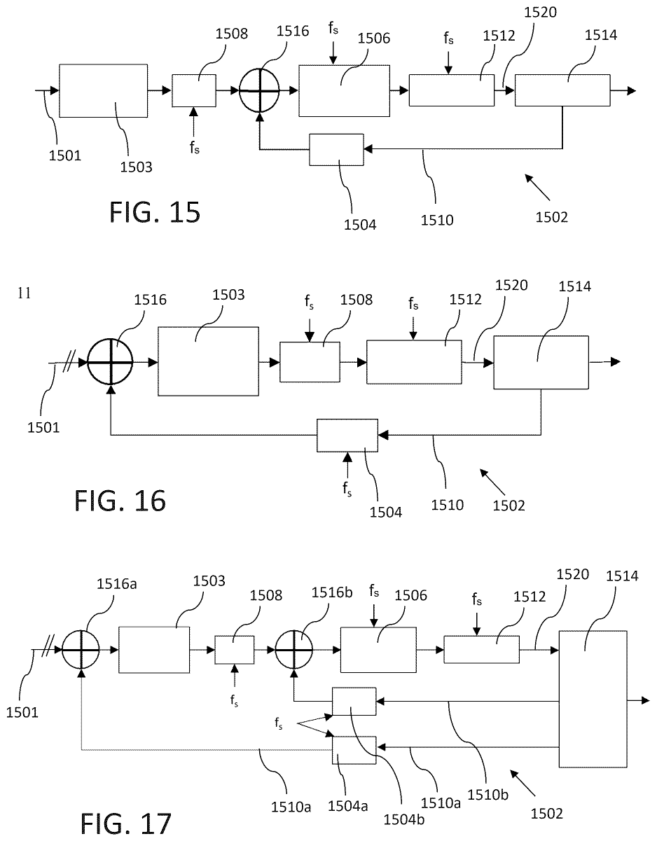

Referring to FIG. 15, a first order bandpass DS loop 1502 may be formed by combining the feedback path 1510 with the output of a sampler 1508 in a summer block 1516, with a DAC (digital-to-analog converter) 1504 connected in feedback path 1510. The input of sampler 1508 is based on an input signal 1501 that is filtered in multiband bandpass filter 1503. Both quantizer 1512 and DAC 1504 may be clocked at fₛ. Quantizer 1512 produces a digitized output 1520. In DSP filter 1514, there may be an additional digital filter section added (not shown) that accounts for the translated carrier frequency of mod(f_{c},fₛ) in the folded band. Note that this places the null of the noise transfer function of the quantization noise coincident with the frequency of mod(f_{c},fₛ) for maximum suppression of the quantization noise and an improvement of the output SNR by a factor of 30 log₂(OSR). If mod(f_{c},fₛ)=0 then the digital filter section may be used as a simple accumulator. Note that the spectrum of the signal in that case may be split into two portions as shown in FIG. 14.

In the case of mod(f_{c},fₛ)=0, there may be additional implementations that are possible. In FIG. 15, the feedback signal and the output signal of sampler 1508 are added as analog signals and passed to an analog integrator 1506. The output is then processed in quantizer 1512. This provides a first order delta sigma loop.

Referring to FIG. 16, the first order band pass delta sigma (BDS) loop may also be implemented by positioning the multiband bandpass filter 1503 after the summer 1516. As shown, DAC 1504 generates narrow pulses with harmonics of the sampling frequency of fₛ. One of these harmonics will be coincident in frequency with the incoming signal.

Referring to FIG. 17, both summer 1516a and multiband bandpass filter 1503 may be incorporated to realize a second order BDS loop. There may be a first feedback loop 1510a to a first summer 1516a and a second feedback loop 1510b to a second summer 1516b, each with a DAC 1504a and 1504b. An advantage of this is an increased quantization noise suppression, such as 50 log₂(OSR), where the new oversampling ratio (OSR) is now relative to the Nyquist frequency of the one-sided folded frequency structure which is now B. There is some control over the placement of the zeros of the noise transfer function. Bandpass filter 1503 may optionally be placed in the path between DAC 1504a and summer block 1516a.

### Generalized Case of M Digitizers and N Input Signals

In the general case where there are M digitizers and N input desired signals in nonoverlapping frequency bands, the objective of the algorithm used to configure the sampling is to select the sampling rates of fₛ₁, . . . f_{sM} such that based on the M digitized output streams, the N desired signals can be extracted without mutual interference. The sampling frequencies may be selected such that the maximum of {fₛ₁, . . . f_{sM}} is minimized and that the digital processing is of minimum complexity in terms of the aggregate of the Boolean operations required to process the signals. Special optimization is required based on the type of signals and on the interpolation operations required. There are well-known methods that may be used to achieve this. Hence it may be assumed that such optimization of {fₛ₁, . . . f_{sM}} and the digital processing can be done such that the advantage of the frequency folding methods can be realized.

As described herein, a sampler is a device that does a time-based instantaneous sample of a continuous time signal, and may be implemented by a sample and hold circuit. The output of a sampler will generally be analog, that is, it can be a continuous variable of a physical property such as a voltage level, an electric current level, or other property. A digitizer receives a continuous time signal and produces an output that is a digital representation of this signal value sampled at a time instance. A digitizer may therefore encompass both a sampling block, which may be any suitable sampler circuit including a S/H circuit, and a quantization block, referred to herein as a quantizer, that quantizes the samples to provide the digital output.

### Implementation of Multiband Bandpass Filters

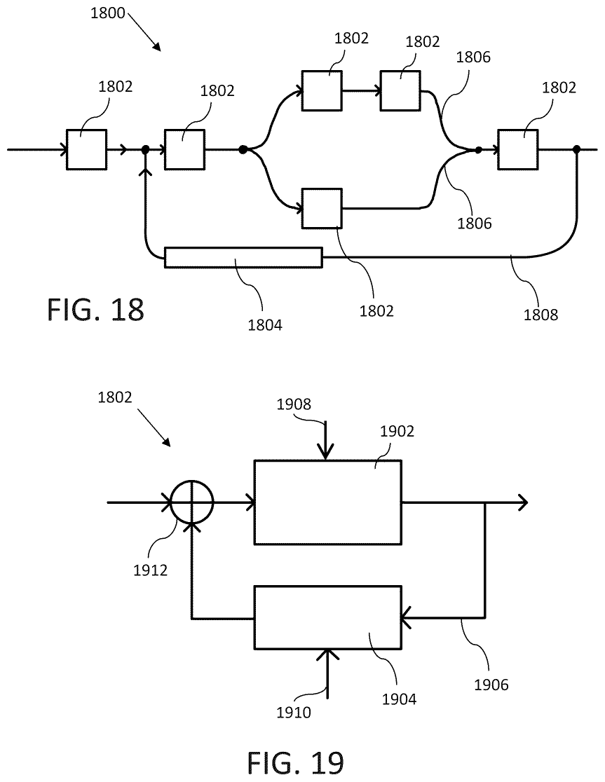

A multiband bandpass filter, which is a bandpass filter that has multiple passbands, may be used prior to folding the bands in the input signal into a composite folded band. As described previously, this multiband filter may be considered as a generalized band pass filter in which the frequency response is characterized by at least one passband. Each passband of the multiband filter is characterized by consisting of at least one resonator pole. Each of these resonator poles may be Q enhanced. Referring to FIG. 18, there is shown a multiband filter 1800 with a plurality of QRs (Q-enhanced resonators) 1802 that are connected in series and parallel in a network of signal branches 1806, with one or more QR 1802 in each branch 1806. As such, the arrangement of QRs 1802 may be arbitrarily designed to achieve a desired frequency response. Multiband filter 1800 may include a feedback path 1808 to form a signal loop. Multiband filter 1800 may include other components, such as a scaling block 1804, in feedback path 1808, or other branches of multiband filter 1800. Some branches may have multiple components, or no components. The various branches 1806 may be connected using splitter and summer nodes.

In the DSR, a bandpass filter used prior to the digitization may have high frequency selectivity such that it can function as an antialiasing filter with an overall bandwidth of B, such that the digitizer sampling can be limited to as low as 2B without resulting in losses in the information of the signal bands processed by the receiver. It is advantageous to have the sampling rate as low as possible as this reduces the rate of processing of the digitizer and the subsequent digital processing. With sub-sampling, where the multiple frequency bands are folded into the sampling band of 0 to fₛ, where fₛ is the sampling frequency, the demands on high frequency selectivity are further challenged. Simulations indicate that the implemented multiband filter may benefit from being designed with resonator poles of very high values of Q, typically over 1000, such as with an actively Q enhanced resonator which is a QR. Additionally, in some examples, the QR components:
a) May be tunable in frequency and Q, with Q values typically >1,000
b) May have agile tuning such that the QR response can settle within several microseconds,
c) May be chip integratable, or in a form of a multi-chip module (MCM) comprised of at least one die.

Referring to FIG. 19, as there are challenges in realizing a pole Q of over 1000 in a compact resonator, wherein the dimensions of the resonator may be much less than the free space wavelength of a signal at the resonance frequency, an active feedback path 1906 connected to a summer 1912 may be provided around a base resonator 1902 of QR 1802 to enhance the Q to a sufficiently high value while maintaining circuit stability. In addition, the phase of the feedback may be adjustable such that the center frequency of Q enhanced resonator (QR) 1802 can be tuned. Through appropriate controls of base resonator 1902 (via control signal 1908) and gain block 1904 (via control signal 1910), the center frequency and/or Q of the frequency response may be adjusted. Base resonator 1902 may be any passive device that has some form of reactive energy storage, such as a delay line, an inductor, a capacitor, an acoustic crystal, an electromagnetic cavity, and so forth. Optionally, base resonator 1902 may have some mechanism of tuning a reactive element property of an external resonator.

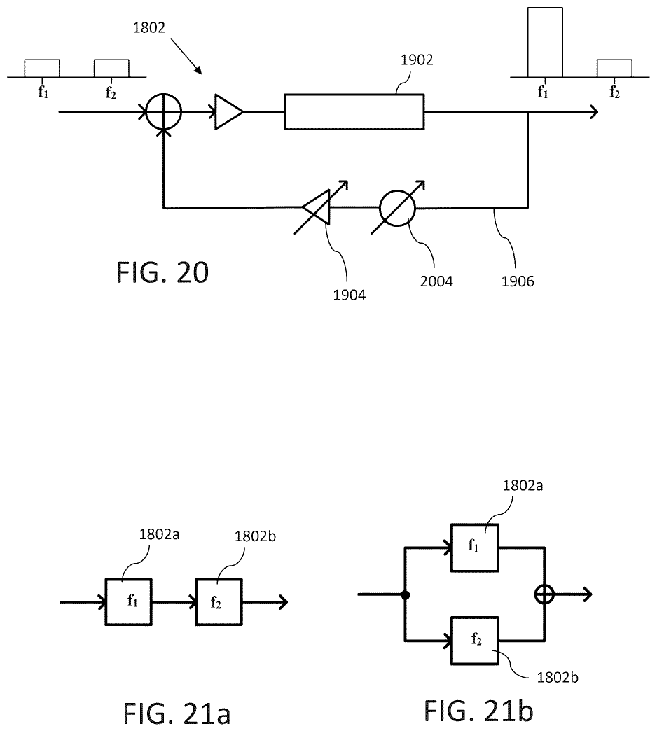

Other suitable designs for QR 1802 may also be used. A possible implementation is shown in FIG. 20, where feedback loop 1906 has a variable gain block 1904 and phase control block 2004. In an example where two signals are received by QR 1802, one centered at f₁ and the other centered at f₂, and where QR 1802 is tuned to the frequency of f₁, the operation of QR 1802 will enhance the signal at f₁ as the feedback around the loop is in phase and adds constructively at the frequency of f₁. However, for the signal at frequency f₂, the feedback signal is out of phase and the signal is not reinforced constructively and therefore, the feedback does not build the signal which passes through the QR with typically a small loss as opposed to f₁ which has a large gain.

Based on this, the multiband filter may be designed with a passband at both f₁ and f₂. The separation of |f₁−f₂| may be much greater than the desired bandwidth around either f₁ or f₂. Referring to FIGS. 21a and 21b, such a filter may be implemented with either a series (FIG. 21a) or a parallel combination (FIG. 21b) of two QR 1802 components, one being tuned for Q enhancement around the frequency of f₁ and the other being Q enhanced for a frequency around f₂. Referring to FIG. 21a, in the series connection of the two QR 1802 components, the first QR 1802a provides that bandpass response for the passband centered at f₁ while the response of f₂ represents a small loss, and the second QR 1802b provides a bandpass response for the passband centered at f₂ while the response of f₁ is a small loss. The overall frequency response of the series connection is a pair of narrow bandpass responses centered at f₁ and f₂. In the parallel configuration, the upper QR 1802a has a bandpass response at f₁ and the lower QR 1802b a bandpass response at f₂ which are combined, giving a composite response again of two narrow passbands, one at f₁ and the other at f₂. In the parallel connection, the gain of QR 1802 at the Q enhanced frequency may be large relative to out of band frequencies. Consequently, the residual response of the frequency f₂ passing through first QR 1802a tuned to the frequency of f₁ may be negligible contrasted with the signal of f₂ passing through the second QR 1802b tuned to the frequency of f₂. Therefore, in the summing operation, the frequency response at f₂ may be dominated by the bandpass response of QR 1802b tuned to the frequency of f₂. For lower Q enhancement, this is less valid and there may be a distortion in the passband. However, for the multiband filter application where the Q enhancement of QR 1802 is high this passband distortion may be considered negligible and therefore the QR components 1802 can be connected in either series or parallel configurations.

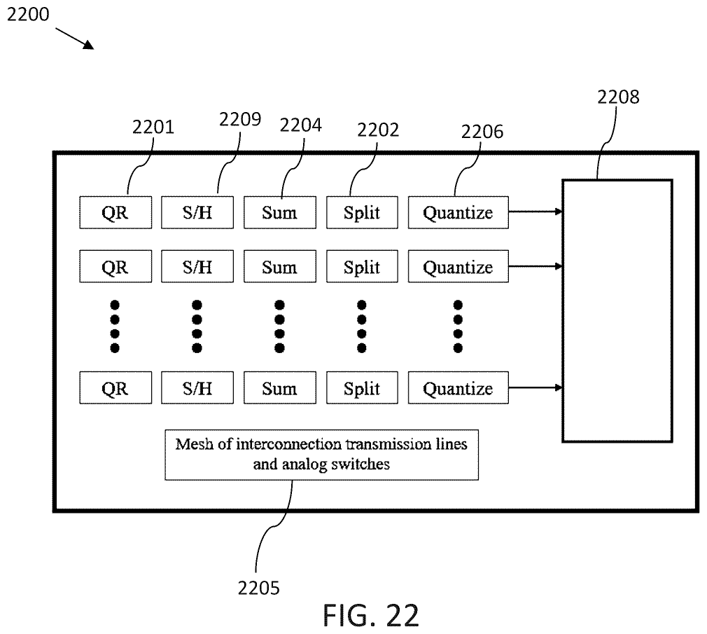

There are many variations of the connections of QR components to define the multiband filter. In some examples, for each of the bandpass responses centered at the set of frequencies of f₁, f₂, . . . , f_{N}, multiple QR components may be assigned to each band. Referring to FIG. 22, a generalized multiband signal processor 2200 may include an array of QR components 2201, samplers 2209, summers 2204, splitters 2202, and quantizers 2206 that pass into digital processor 2208. These may be connected in a network by using an array of analog switches and interconnecting transmission lines, represented by block 2205. The concept may be compared to an FPGA consisting of an array of arithmetic logic unit (ALU) components and digital interconnecting switches. With firmware, an arbitrary network configuration of a plurality of QR 2201 and quantizer components 2206 may be connected through analog switches and transmission lines 2205 to realize an arbitrary set of series and parallel connections such that the resulting frequency response of the multiband filter will have at least one passband response. A plurality of passbands may be configured of arbitrary bandwidth for optimal digitization and digital processing. Other components may also be included in the generalized multiband signal processor 2200.

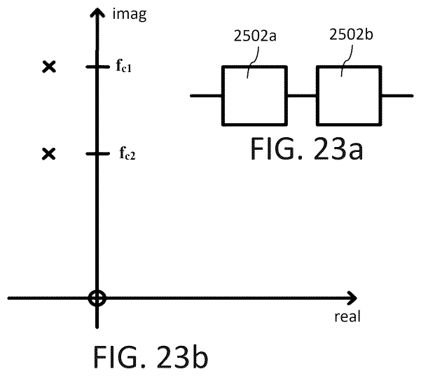

As an example of a passband filter design, referring to FIGS. 23a and 23b, there may be two QR components 1802 in series. In this example, first QR 2502a is tuned to the center frequency of f_{c1} and second QR 2502b is tuned to f_{c2}. The resulting positions of the Q-enhanced poles are shown in FIG. 23b.

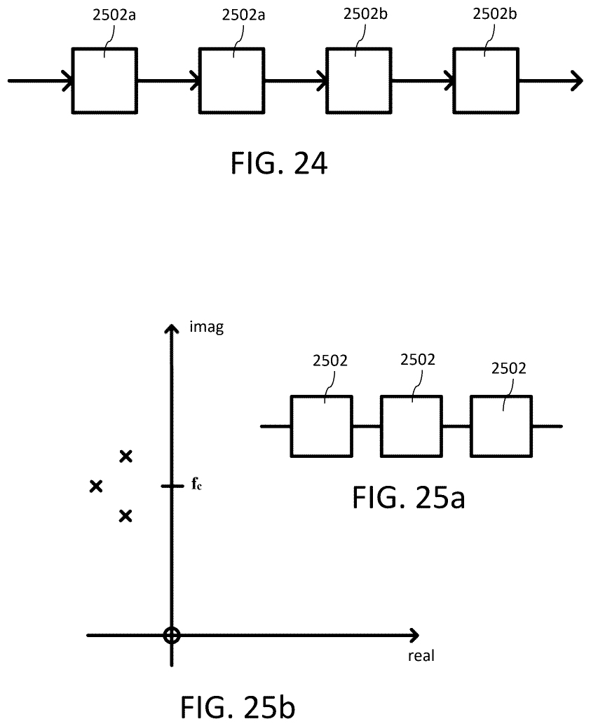

As a further example, referring to FIG. 24, there may be four QRs 2502a and 2502b configured to have two poles for a passband centered at f₁ and two poles for a passband centered at f₂. In the series connection of the QRs, the order is arbitrary. In this example, the two QRs 2502a tuned to f₁ are first followed by the two QRs 2502b tuned to f₂. Adding additional poles allows for higher frequency selectivity with slightly broader passbands and correspondingly steeper transitions.

Referring to FIG. 25a, a further example may include three QRs 2502 tuned to produce a single passband centered around the frequency of f_{c}. The three QRs 2502 are tuned in terms of center frequency and Q as shown by the pole diagram in the s-plane in FIG. 25b. This may result in an equal-ripple passband with sharp transitions on the band edges. Alternately, the three QRs may be tuned for a flatter passband which would result in smoother transitions on the band edges.

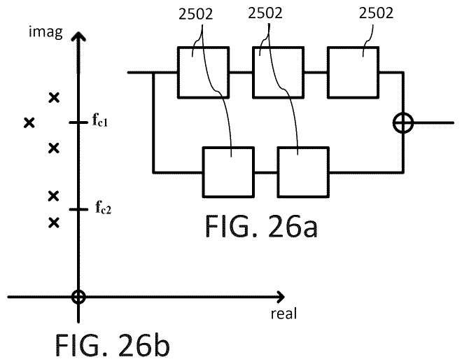

Referring to FIG. 26a, a further example includes a series-parallel combination of QR components 2502 that are tuned to produce two separate bands at f_{c1} and f_{c2} simultaneously, with the resulting pole positions shown in FIG. 26b.

As described previously, the relative gain of the passband may be controlled to allow a digitizer to see all of the passband signals simultaneously. In the parallel configuration, as in FIG. 26a, the gain of each branch may be set by either modifying the Q of the enhanced poles (i.e. the higher the Q enhancement the higher the gain) or by applying a variable gain block (not shown) in one or both branches.

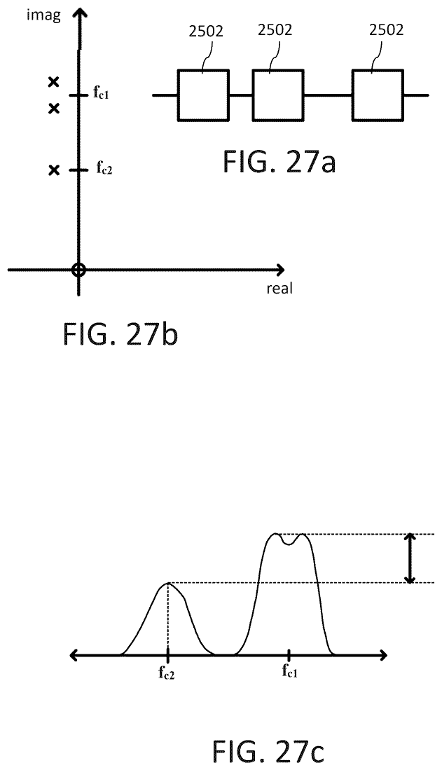

Referring to FIG. 27a, an alternate approach to relative gain control of the passband responses is a series combination of QR components 2502 tuned to pass two separate bands at f_{c1} and f_{c2} simultaneously, with the pole positions shown in FIG. 27b. A relatively higher gain for f_{c1} may be achieved with more QR poles for the f_{c1} signal and a single lower Q pole for f_{c2}. Hence, the QR components may be controlled to de-emphasize the signal at f_{c2} relative to the signal at f_{c1} prior to the digitizer. FIG. 27c depicts the relative gain difference of such a combination.

### Direct Sampling Conditionality

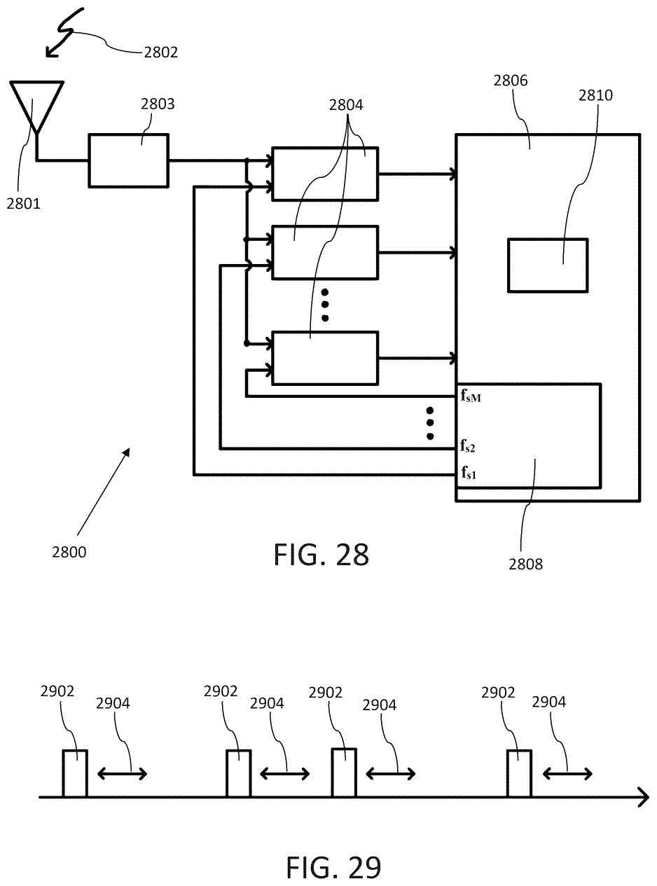

Referring to FIG. 28, a general block diagram of a receiver 2800 is shown. Receiver 2800 has an antenna 2801, such as a broadband antenna, that captures a signal 2802, which enters multiband filter 2803. While the discussion herein focuses primarily on wireless systems and wirelessly received signals, receiver 2800 may be adapted to work with both wired or wireless signals and systems. Multiband filter 2803 may be configured based on the set of desired signals that the receiver has to process, based on the design and control strategies discussed above. The output of multiband filter 2803 is sent to an arbitrary number M of digitizers 2804, which are operated at different sampling rates of fₛ₁, fₛ₂ . . . f_{sM}. The M streams of digitized samples from digitizers 2804 enter a digital processing block 2806 that then extracts the information from the set of desired inputs. The sampling signal for the m^{th} digitizer may be denoted as ssₘ and has a clocking frequency of fₛₘ for the m^{th} digitizer, which may be generated from a clock synthesizer 2808 within digital processing block 2806.

### System Sampling Clock

In general, it may not be necessary for the sampling clocking signals to have a distinct frequency. It may be an arbitrary signal, provided that the time between samples is sufficient for the digitizer to complete the conversion operation. This is illustrated in FIG. 29, which depicts sampling clock pulses 2902 at ssₘ and the resulting digitization conversion intervals 2904. The advantage of this generalization is that the digital processing has more flexibility in processing the samples for extracting the information from the plurality of desired signals.

In summary, there are various algorithms for generating the required clocking signals for the digitizers. If there is a single digitizer with a sampling frequency of fₛ, it is necessary that the signal bands be located in the folded spectrum from 0 to fₛ. If signal n has a frequency range of {fₙ₁,fₙ₂} where fₙ₁ is the lower frequency of the signal fₙ₂ is the upper frequency and another signal n′, has a frequency range of {f_{n′1},f_{n′2}} where f_{n′1} is the lower frequency of the signal f_{n′2} is the upper frequency, then the pairwise conditions implied by

mod({fn1,fn2},fs)≠mod({fn′1,fn′2},fs)

must be satisfied. Otherwise, the digitized signals of n and n′ cannot be separated and will mutually interfere. Note that for a sufficiently high fₛ these conditions can all be satisfied. The objective of the configuration algorithm determining the value of fₛ based on the set of desired signals to process is to minimize fₛ.

### Impact of RF Sampling on Clock Rate

The sampler may be based on a sample and hold circuit that is a buffer amplifier with low impedance output that feeds into an analog transistor switch operating over a very narrow aperture time (on the order of tens of picoseconds) and charges up a small capacitor. In this example, the capacitor may hold the analog sample just long enough for the ADC to process it. Typically, the ADC would be a successive approximation register (SAR) and can implement a number of bits of resolution. The more bits desired, the faster the clock rate has to be, which may be at least 6 times the sampling rate for a 6-bit quantizer, or 10 times the sampling rate for a 10-bit quantizer, etc.

The architecture discussed herein, or variations thereof, may be used to mitigate some or all of the above disadvantages of current signal processing methods and provide a receive channel with the characteristics of high digital throughput and dynamic range.

Conditions when Multiple Digitizing Bands are Processed

As the number of desired signals increases, the result of the minimum fₛ may be too high, and a plurality of digitizers may be required. Overlapping may then be allowed (as discussed previously) and the N desired signals in the digital processing may be separated, provided that they are able to be resolved in downstream processing. This is generally the case if there is some redundancy in the digital sampling. In particular, if the set of sampling frequencies are non-commensurate with the set of signals, there may be enough redundancy in the sampling to resolve the set of signals. In other words, it may be possible to resolve the signals by obtaining a set of sampling frequencies of lower cardinality than the set of signals that provides sufficient sampling for the degree of freedom (DOF) count of the set of signals with a minimum aggregate sampling rate of the set of sampling frequencies.

As one example, with three overlapping signals at different frequencies, it may be possible to obtain two versions of the signal overlaps with two quantizers, which may make the signals resolvable. A similar approach can be used for a higher number of signals. Other strategies may be used to resolve the signals, depending on the composition of the signals.

### Using Artificial Intelligence to Mitigate Information Loss

If the signals are not able to be properly resolved, there may be a degradation in the information contained in the input signals that is extracted and available at the output of the digital processing. However, if the loss of information is minor, this loss can be taken into account in the optimization process of configuring the sampling frequencies of fₛ₁, fₛ₂ . . . f_{sM}. For instance, in the above example of FIG. 4, suppose that in the folded spectrum there is a partial overlap of the GPS signal and the cellular signal. Both of these signals are significantly coded and in typical cases the loss of information may be negligible, which may be determined using Artificial Intelligence (AI). For instance, AI may be able to determine that if the cellular signal is in fade, then the overlap will result in a brief outage until the fade recovers and the cellular signal again decodes error free. Likewise, AI may be able to monitor the GPS signal to determine the presence of a temporary fade followed by a brief outage. However, if AI determines that all the satellite signals from the GPS did not fade simultaneously, then signal redundancy may be sufficient to maintain the GPS tracking.

There are possible mitigations that can be built into the AI driven optimization algorithms of selecting fₛ₁, fₛ₂ . . . f_{sM}. It is not necessary to detail these as it can be understood that such algorithms exist within the AI algorithm library, and therefore the impact of the spectral overlap of signals in the folded spectrum can be minimized. In this context, feedback from the decoding of the desired signals in the digital processing may be incorporated into the algorithm that selects fₛ₁, fₛ₂ . . . f_{sM} to mitigate the prevalent decoding errors. The algorithm could for instance dither the values of fₛ₁, fₛ₂ . . . f_{sM} which changes the degree of signal overlap, or it can change the amplitude of the passband responses in the multiband filter. Feedback from the decoding process can be used to determine if the spectral overlap caused a notable degradation in the decoding information. If so, then the mix of fₛ₁, fₛ₂ . . . f_{sM} can be modified to reduce the overlap of the compromised signals. If the overlap had undetectable degradation, then the issue is in the received signal itself and there is no degradation from the DSR based on the multiband filter. Then no changes are made to fₛ₁, fₛ₂ . . . f_{sM}.

This also raises the possibility of using AI algorithms with supervised training of the digital processing of the selection of fₛ₁, fₛ₂ . . . f_{sM} for a specific set of desired signals. It is sufficient to state that supervised training or reinforcement learning can be used to devise a neural net algorithm for setting of fₛ₁, fₛ₂ . . . f_{sM}.

### Control and System Self-Configuration

As shown in FIG. 28, a controller 2810 may be incorporated into the architecture that controls various operational parameters, such as the frequency, bandwidth, and gain or Q of each passband in the multiband filter, the sampling frequency, the digitizer, and other components discussed herein, such as the configuration of a modularized multiband filter and the AI aspects for information loss mitigation. The controller may use well-known control algorithms and/or techniques, and may be based on external inputs and/or readings or feedback from the architecture itself. While controller 2810 is shown as being incorporated into digital processor 2812, it may also be a stand-alone component, or the functions may be distributed between one or more processors. A suitable controller may also be incorporated into any of the architectures discussed above that involve an adjustable parameter, such as a tunable bandpass filter, or a sampling block with an adjustable sampling frequency.

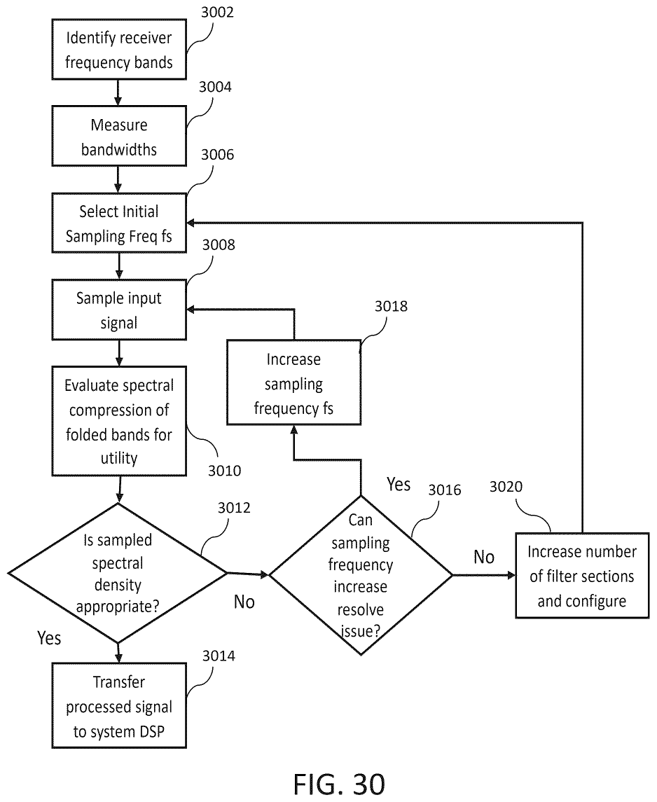

In some examples, controller 2810 may involve machine learning, and may be self-configurable, in which case the methods that are used to optimize the system performance against a set of desired results are akin to a neural network in that they are computational models that consists of interconnected hierarchical and sequential computational nodes that receive input data, perform mathematical computations on the input, and produce output data. In the example discussed below, the input layer receives data, which is then processed by a series of hidden layers that apply tailored mathematical operations to the input to achieve desired results. This RF Sampling architecture is based substantially on artificial intelligence (AI) methods to monitor the status of all feeds for system configuration optimization that may include:
AI aspect 1: Frequency bands and bandwidths of all input signals for processing
AI aspect 2: Determination of:
   a. Required number of QR modules to be deployed
   b. Optimal configuration of each QR module
   c. System configuration power requirement and consistency with system requirement—adjusting to meet system priority requirement against available power based upon system sensor inputs to provide power utilization
      Referring to FIG. 30, an example of a process flow for top level self-configuration is shown. The process may vary, depending on the particular system design. In step 3002, the receiver frequency bands are identified; in step 3004, the bandwidths are measured; in step 3006, a sampling frequency fa is selected, and used to sample the input signal in step 3008. The spectral compression of the folded bands is evaluated for utility in band 3010. In decision block 3012, a determination of whether the sampled spectral density appropriate is determined. If yes, the processed signal is transferred to the system DSP in step 3014. If no, a determination of whether increasing the sampling frequency can resolve the issue in decision block 3016. If yes, the sampling frequency fₛ is increased in step 3018, which is then used to sample the input signal in step 3008. If no, the number of filter sections is increased and configured in step 3020, and returned to step 3006.

### Spurious Passbands

In some cases, the multiband filter, such as when the multiband filter involves one or more QR components as discussed above, may generate one or more spurious bands distinct from the desired passband, which may be based on the Nyquist curve. These spurious bands may interfere with other desired passbands when folded into the folded frequency profile after sampling. To avoid this, the characteristics of the spurious bands may be calculated, and then the spurious bands may be treated as additional passbands of the multi-band filter. At the processing stage, the spurious bands may then be removed as bands without desired information, while information is extracted from signals in desired bands.

The subsampling frequency may then be determined as the minimum sampling frequency that will sufficiently separate the spectral content of the undesired spurious passbands as mapped into the folded band, such that the bands are distinct, i.e. there is a tolerable overlap with the desired band. As noted previously, tolerable overlap depends on the spectral context, which is the relative spectral content of the mapped desired band to the mapped undesired signals, and the level of signal to noise as a relative floor for tolerable information loss in the processing of the desired signal.

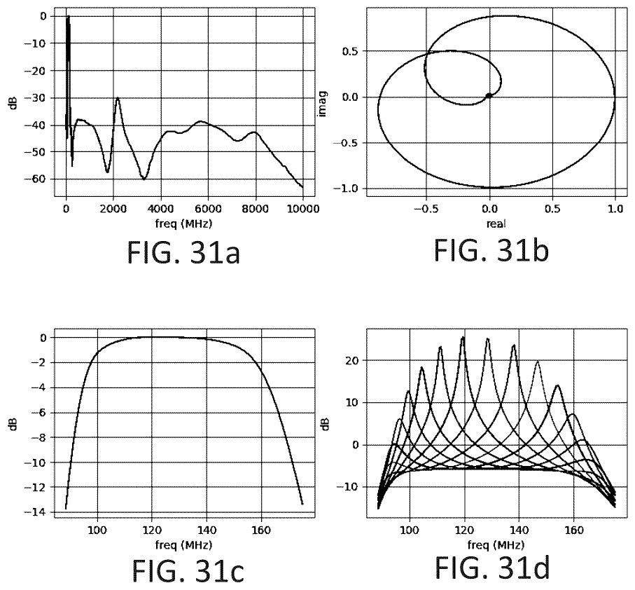

By way of example, consider a bandpass filter with a certain number of bands at different frequencies, where certain bands may be suitable for Q enhancement, while others are not. For example, in one switchable bandpass filter, it was observed that the first 6 lower frequency bands of the bandpass filter were suitable for Q enhancement. However, the upper 4 bands were problematic in that the throughput delay was too high. This resulted in an issue with the Nyquist response curve in that it could not be Q enhanced without spurious bands forming. Referring to FIGS. 31a to 31d, the overall frequency response of the bandpass filter shows the strongest passband at the lowest frequency, and the higher frequency spurious bands shown in FIG. 31a. The Nyquist filter response plot is shown in FIG. 31b, the zoomed in passband is shown in FIG. 31c, and the calculated possible passband Q enhancements shown in FIG. 31d. Not shown is spectral regrowth that may be significant above 10 GHz for all the bands.

The Nyquist response curve in FIG. 31b is suitable for Q enhancement as the inner encirclements are sufficiently removed from the outer encirclement. This implies that the Q can be enhanced without forming spurious bands, except when Q enhancing at the passband edges. This is evidenced in FIG. 31d where it can be seen that at the band edges-below about 80 MHz and above about 160 MHz—there are issues with spurious band growth. A compensation would be to increase the Q enhancement further such that the main peak is relatively higher than that of the spurious peaks.

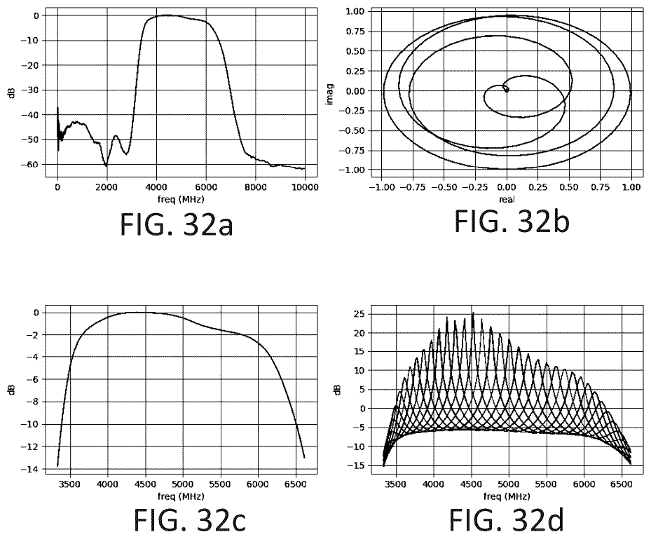

The next highest frequency band (just above 2000 MHz) is characterized in FIGS. 32a to 32d. FIG. 32a shows the overall frequency response, FIG. 32b shows the Nyquist response plot, FIG. 32c shows the zoomed in passband with 3 dB down points near 3600 MHz and 6100 MHz, and FIG. 32d shows the calculated potential passband Q enhancements. The issue of the increased relative delay (discussed above) is evidenced by the encirclements in the Nyquist response plot. As the inner encirclements of FIG. 32b are getting close to the outer encirclements, good spurious band suppression becomes difficult.

Through optimized circuit design, the delay through the filter may be limited, which may help reduce the spurious bands. However, limiting the delay may require the complexity of the filter to be reduced. In addition, it may not be possible to eliminate delay in some other components. Further, constraining the delay may place a limit on the filter order which could impact the desired passband response.

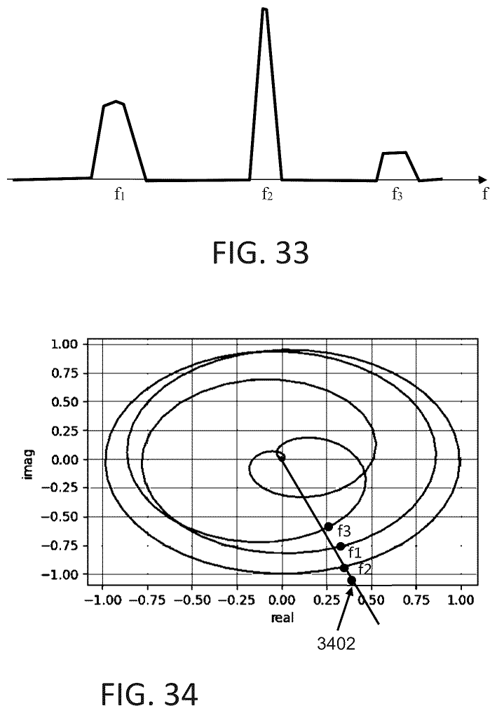

Another approach is to treat the Q enhanced filter with the spurious bands as a multiband filter. The higher the Q enhancement, the more the spurious bands are reduced, but they are still present. Hence, the Q enhanced filter may generate a passband as illustrated in FIG. 33. The corresponding Nyquist response curve could look something like FIG. 34.

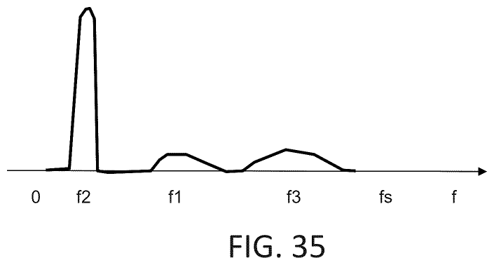

Referring to FIG. 34, if Q enhancement is increased, then the distance from the operating point 3402 to f₂ is shortened proportionally more than the distance from the operating point to f₁ or f₃. Hence the peak at f₂ increases much more rapidly with Q enhancement than the spurious bands. However, as Q is increased beyond a certain point, the bandwidth may become too small. This may be ameliorated by adding additional filter or QR components, however the complexity of the overall filter increases in doing so. By subsampling the output at a Nyquist rate that can accommodate both the desired passband and the two spurious bands, the folded band may be generated that has a frequency response as shown in FIG. 35.

As long as the desired signal at the mapped f₂ is distinct from the mapped spurious bands of f₁ and f₃, then there is no issue with the spurious bands of the filter. The digitizer output is coupled into the DSP for further processing and information extraction and the spurious bands may be easily dealt with during digital signal processing.

In general, a filter that generates spurious bands, such as bands that are a result of the parasitic delay of an active feedback filter comprising a resonator and a gain element in a feedback loop, may be considered a multiband signal, and interference between the desired passband and the spurious passband(s) may be compressed into a folded band by appropriate selection of a sampling frequency (fₛ) such that the spectral content of the mapped spurious bands do not overlap the spectral content of the mapped desired band when the full signal spectrum is mapped into the folded band. In some cases, the signal being filtered may be a multiband signal, i.e. an input signal with a plurality of desired signals in distinct bands that is filtered by a multiband bandpass filter, which may produce one or more spurious bands. In this case, the one or more spurious bands are assumed to be distinct from the desired signals in the other distinct bands. The sampling frequency is then selected such that the spurious bands do not overlap with any of the desired bands when mapped into the folded band. If the spurious bands overlap with one of the desired signal bands, further processing may be required, such as by processing one or more desired signal bands in one or more alternate filter paths. The set of digitizer outputs may be combined in the DSP for further processing and information extraction, despite the presence of the spurious bands. As an example, there may be an active feedback filter designed for broadband tuning, such as a resonator that is based on a low Q resonator that is easily tuned over multiple octaves with, for example, switched delay line elements and switched lumped capacitor elements. In some cases, the active feedback filter may include 3 or more tunable resonators along with a number of low Q resonators that could be a bank of capacitors switched with FET or MEMS switches. The overall loop delay introduced by these components may be ignored as the potentially multiple spurious bands generated can be mitigated with the subsampling method described above. The question becomes whether a sampling frequency can be determined that will adequately separate the desired band from the spurious bands. This may be determined by a controller, such as an adaptive controller, that senses the incoming signal frequencies, determines the frequencies of the spurious sidebands, and determines a suitable sampling frequency, where the decisions may be supported by Artificial Intelligence.

It will also be understood that, if spurious bands are dealt with in this manner, there is additional design flexibility. In particular, the number of resonators, a potential source of spurious signals, may have less of an effect on the output of the signal processing. This adds to design flexibility for enhancing the circuit tuning range, overall system performance, and stability. Similar considerations also apply to other filter designs, such as a SAW-enhanced active feedback filter, where spurious bands may be generated when Q-enhanced, which suggests that fewer resonator or filter stages may be required to achieve high-Q signals when combined with direct sampling using the sub-sampling methodology described herein.

In one example, the resonator may be as simple as a delay line. In this case, the spurious passbands may be uniformly spaced in frequency, and the mapping into the folded band will result in ideal sequencing of the mapped bands as these will be regularly spaced. The fₛ for this case will be minimum. Note that a simple multi-octave tuning phase controlled active feedback resonator may be realized with only a delay line and then sampling at fₛ to fold the bands.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context requires that there be one and only one of the elements.

The scope of the following claims should not be limited by the preferred embodiments set forth in the examples above and in the drawings, but should be given the broadest interpretation consistent with the description as a whole.

1. A signal processor for a multiband signal, comprising:
a signal input connected to receive an input signal; and
a sampling block that samples the input signal at a sampling frequency;
wherein, for an input signal that comprises a composite signal defined by a plurality of sub-bands, each of the plurality of sub-bands having a central frequency and a bandwidth:
the plurality of sub-bands are mapped into a folded composite band as a plurality of folded sub-bands by the sampling block;
the plurality of folded sub-bands are distinct within the folded composite band; and
the folded composite band has a narrower bandwidth than the composite signal.

2. The signal processor of claim 1, wherein the sampling frequency of the sampling block is adjustable, and the signal processor further comprises a controller that is programmed with instructions to:
based on the central frequency of each of the plurality of sub-bands, determine a sampling frequency of the sampling block to generate the folded composite band; and
adjust the sampling frequency of the sampling block to achieve desired characteristics of the folded composite band.

3. The signal processor of claim 2, wherein the controller is further programmed with instructions to adjust the sampling frequency such that the plurality of folded sub-bands are distinct within the folded composite band.

4. The signal processor of claim 2, wherein the controller is further programmed with instructions to adjust the sampling frequency based on measurements from a downstream signal processing block.

5. The signal processor of claim 1, wherein the sampling frequency is at least twice the sum of the bandwidths of each of the plurality of folded sub-bands.

6. The signal processor of claim 1, wherein the sampling block comprises more than one sampling block, each sampling block sampling the input signal at a different sampling frequency.

7. The signal processor of claim 1, further comprising a quantizer and a digital signal processor downstream of the sampling block.

8. The signal processor of claim 7, wherein the composite signal comprises one or more information bands and one or more spurious bands, the digital signal processor being adapted to extract information from the one or more information bands and remove the one or more spurious bands.

9. The signal processor of claim 1, wherein the signal input comprises a multiband filter, the multiband filter being configured to generate the input signal from a received signal.

10. The signal processor of claim 9, wherein the multiband filter is tunable and comprises a plurality of passbands that are adjustable in bandwidth, frequency, gain, or combinations thereof.

11. The signal processor of claim 9, further comprising a feedback loop that extends from downstream of the sampling block to upstream of the multiband filter, the feedback loop comprising a processing block that is configured to reduce noise across a select frequency range of the folded composite band.

12. The signal processor of claim 9, wherein the multiband filter comprises a multi-pole resonator.

13. The signal processor of claim 12, wherein the multiband filter comprises a plurality of configurable resonator stages that are selectively connectable in parallel or in series.

14. The signal processor of claim 13, wherein the multiband filter comprises a plurality of tunable resonators with active feedback.

15. The signal processor of claim 13, further comprising a filter controller that is programmed with instructions to adjust the multiband filter such that the folded sub-bands are distinct within the folded composite band.

16. The signal processor of claim 1, wherein the sampling block generates a plurality of spectral copies for each of the plurality of sub-bands, and wherein each of the plurality of folded sub-bands comprises one of the plurality of spectral copies.

17. A multiband receiver comprising:
an antenna; and
a signal processor for a multiband signal as defined in claim 1,
wherein the signal input of the signal processor is connected to the antenna.

18. A method of processing a multiband signal, comprising the steps of:
sampling a composite signal at a sampling frequency to produce a folded composite band, the folded composite band being defined by a plurality of sub-bands, and wherein the sampling frequency is selected such that:
the plurality of sub-bands are mapped into the folded composite band as a plurality of folded sub-bands;
the plurality of folded sub-bands are distinct within the folded composite band; and
the folded composite band has a narrower bandwidth than the composite signal.

19. The method of claim 18, further comprising the step of adjusting the sampling frequency based on the plurality of sub-bands such that the plurality of folded sub-bands are distinct within the folded composite band.

20. The method of claim 18, further comprising the step of filtering an input signal in a multiband filter to produce the folded composite band, the multiband filter comprising a plurality of passbands.

21. The method of claim 20, wherein the multiband filter comprises a plurality of tunable resonators with active feedback.

22. The method of claim 20, wherein filtering the input signal comprises adjusting the plurality of passbands in bandwidth, frequency, gain, or combinations thereof.

23. The method of claim 22, wherein the multiband filter comprises a plurality of configurable resonator stages that are connectable in parallel or in series.

24. The method of claim 18, further comprising the step of receiving the composite signal by an antenna upstream of the multiband filter.

25. The method of claim 18, wherein the sampling frequency is at least twice the sum of the bandwidths of the plurality of folded sub-bands.

26. The method of claim 18, further comprising the step of sampling the composite signal using a plurality of sampling blocks, each sampling block sampling a portion of the composite signal.

27. The method of claim 18, further comprising the steps of quantizing the folded composite band to produce a quantized folded band and processing the quantized folded band in a digital signal processor.

28. The method of claim 27, wherein the plurality of folded sub-bands comprises one or more information bands and one or more spurious bands, and wherein processing the quantized folded band comprises extracting information from the one or more information bands and removing the one or more spurious bands.

29. The method of claim 18, wherein sampling the composite signal generates a plurality of spectral copies for each of the plurality of sub-bands, and wherein each of the plurality of folded sub-bands comprises one of the plurality of spectral copies.
